(19) United States
(12) Patent Application Publication
(10) Pub. No.: US 2011/0209598 A1
(43) Pub. Date: Sep. 1, 2011

(54) Portable preamplifier for musical instruments

(76) Inventor: Douglas James Millar, Ota-ku (JP)

(21) Appl. No.: 12/714,496

(22) Filed: Feb. 28, 2010

(51) Int. Cl. G10H 3/00

(52) U.S. Cl. 84/723

(57) ABSTRACT

The present invention relates to a portable preamplifier for musical instruments which is particularly useful for electric guitars. The preamplifier has a body which houses an electronic system for amplifying and shaping the frequency spectrum of signals from the guitar and a battery for supplying power to the electronic system. A short, shielded input audio cable is permanently attached to the preamplifier body, is electrically coupled to the electronic system input, and terminates in an input phone plug. The preamplifier is also provided with an output phone jack. The preamplifier is portable and can be physically attached to a guitar strap or to the musician's clothing. When the input phone plug is inserted into a guitar output jack and an instrument cable is inserted into the preamplifier output phone jack, amplified and spectrally shaped signals from the guitar can be delivered via the instrument cable to a guitar amplifier/loudspeaker, mixing board, or other audio signal device. Portability allows the shielded input audio cable to be short while giving the musician freedom of movement.

### BACKGROUND OF THE INVENTION

Pickups for electric guitars and other musical instruments are well known in the art. Generally, such musical instrument pickups operate by passing a magnetic field, modulated by vibrations of the musical instrument, through a coil of electrically conductive wire. U.S. Pat. No. 1,915,858 to Miessner discloses such a pickup. The electrical output of such a pickup is often delivered via an instrument cable to a guitar amplifier/loudspeaker, headphone set, mixing board, or other audio signal device.

A portable preamplifier is often placed in-line with the instrument cable, positioned close to but outside of the musical instrument, in order to provide impedance matching, gain, audio spectrum shaping, and possibly other signal processing. Such a portable preamplifier includes a method to attach it to a guitar strap, to the musician's clothing, or directly to the musical instrument. Examples of such preamplifiers in the market are called headphone amplifier, mini guitar amplifier, effects unit, and effects processor. Such a portable preamplifier requires a method to electrically connect the output of the musical instrument to the input of the portable preamplifier. Prior art methods to accomplish this connection are:

(1) The preamplifier can be provided with an input phone jack and an output phone jack. A short instrument cable is plugged into the instrument output jack and also into the preamplifier input phone jack to electrically connect the instrument to the preamplifier. The preamplifier has a clip or other attachment method to connect it physically to a guitar strap or to the musician's clothing. There are a number of problems with this method:
(a) Two pieces of equipment are required to use the preamplifier: the preamplifier itself and a short instrument cable to connect it to the musical instrument.
(b) In comparison to plugging the instrument cable directly into the musical instrument output jack, this method introduces two additional electrical connectors in the instrument signal path. Each of these connectors has non-zero risk of failure.
(c) The electrical capacitance of the short instrument cable depends on its length and construction. If for any reason the original cable is replaced by a different cable, the electrical capacitance may be changed, and this may cause an undesired change in the frequency spectrum of the preamplifier output signal.
(d) The input and output of the preamplifier can be accidentally interchanged, since each phone jack can accept either the input or the output phone plug. This introduces a mechanism for failure of the system which can be critical in a live performance application.
(e) For a preamplifier that detects insertion of a phone plug into the input or output phone jack to effect connection of the battery, there is a possibility of confusion over which phone jack performs this function. This can result in an inadvertent failure to disconnect the battery when the preamplifier is not in use, leading to draining of the battery.
(2) A preamplifier input phone plug can be connected to and project directly from the case of the preamplifier. Such an input phone plug is plugged into the musical instrument output jack to connect the preamplifier both electrically and physically to the instrument. U.S. Pat. No. 5,018,204 to Christian discloses such a method. This method is suitable for a preamplifier contained in a small case, but if a large case is required in order to contain a larger battery, or additional controls, or additional electronic circuitry, then such a large case may add excessive weight to the instrument or interfere with playing the instrument.
(3) The preamplifier components can be contained in two separate cases connected together by a cable containing a number of electrical conductors. A preamplifier input phone plug is connected to and projects directly from the first case. The first case contains some of the preamplifier components. The input phone plug is plugged into the musical instrument output jack to connect the portion of the preamplifier in the first case, both electrically and physically, to the instrument. The second case contains the remaining preamplifier components. U.S. Pat. No. 5,585,767 to Wright describes such a method. There are a number of problems with this method:
(a) Separation of the preamplifier components into two cases adds physical complexity to the preamplifier.
(b) Separation of the preamplifier components into two cases having a limited number of interconnecting conductors imposes a restriction on the electrical circuit design.
(c) In comparison to plugging the instrument cable directly into the musical instrument output jack, this method introduces two additional electrical connectors in the instrument signal path. Each of these connectors has non-zero risk of failure.
(d) Although protection against electrostatic discharge (ESD) to the input plug could probably be added by adding additional components inside the first case, the circuit diagram of the claimed system does not contain such protection and the patent does not suggest any method to include such protection. The preamplifier is very likely to be damaged by ESD during normal use.

### SUMMARY OF THE INVENTION

The present invention relates to a portable preamplifier for musical instruments which avoids the above-discussed problems of prior art methods to electrically connect the output of the musical instrument to the input of the portable preamplifier. This is accomplished by adding a short, shielded input audio cable permanently connected to and projecting from one end of the preamplifier body, and terminating in a quarter-inch mono phone plug which is electrically coupled to the preamplifier input.

Because the preamplifier of the present invention has a permanently attached input audio cable, the requirement for a separate piece of equipment (a short instrument cable) is eliminated. Also, in comparison to plugging the instrument cable directly into the musical instrument output jack, only one additional electrical connector is added in the instrument signal path. Also, because the input audio cable is not replaceable, the electrical capacitance of this cable is fixed and the electronic signal processing system can be optimally designed for this known capacitance value. Also, the input and output of the preamplifier cannot be accidentally interchanged because the input connector is a phone plug and the output connector is a phone jack. Also, for an embodiment of the present invention that includes a means to detect insertion of the instrument cable to cause the battery to be connected, there is very little chance of confusing which phone plug performs this battery connect function since almost all commercially available equipment using this method detects the insertion of a plug into the equipment. Also, if a relatively large or heavy preamplifier case is required, then it is more convenient for that case to be physically attached to a guitar strap or to the musician's clothing rather than directly to the output jack of the musical instrument.

The portable preamplifier of the present invention includes a body defined by a case which contains the circuitry of an electronic signal processing system and a power source for this electronic system. The power source, which is accessible through a door in the case, is preferably a 9 volt battery. The case also contains electronic circuitry to protect against electrostatic discharge (ESD).

Permanently connected to and projecting from one end of the case is a short, shielded input audio cable terminating in a quarter-inch mono input phone plug which is electrically coupled to the input of the signal processing system within the case. This audio cable is preferably 2 feet long, excluding the length of the input phone plug. The input phone plug is suitable for insertion into a mating output jack on the musical instrument to couple electrically the instrument to the electronic system.

The preamplifier of the present invention is also provided with an output phone jack into which an instrument cable can be inserted to deliver amplified signals from the musical instrument to a guitar amplifier/loudspeaker, mixing board, or other audio signal device.

### BRIEF DESCRIPTION OF THE DRAWINGS

FIG. 1 is a schematic drawing of a prior art preamplifier system incorporating input and output phone jacks in the preamplifier body.

FIG. 2 is a schematic drawing of a portable preamplifier system according to the present invention.

FIG. 3 is an outside view of a portable preamplifier according to the present invention.

FIG. 4 is an electrical circuit block diagram of an electronic signal processing system according to the present invention.

### DETAILED DESCRIPTION

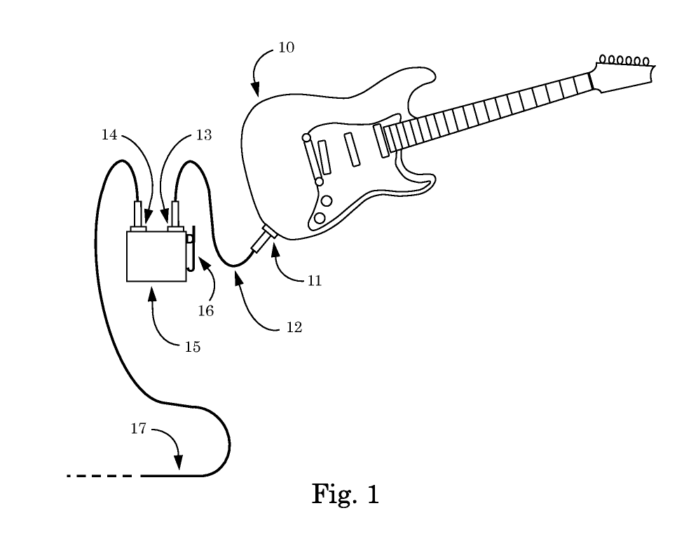

FIG. 1 is a schematic drawing of a prior art preamplifier system incorporating input and output phone jacks in the preamplifier body. The short instrument cable 12 is plugged into the output jack 11 of the guitar 10 and into the input phone jack 13 of the preamplifier 15. The instrument cable 17 is plugged into the output phone jack 14 of the preamplifier 15. The instrument cable 17 delivers amplified signals from the guitar 10 to a guitar amplifier/loudspeaker, mixing board, or other audio signal device (not shown). The clip 16 is used to attach the preamplifier 15 to a guitar strap or to the musician's clothing.

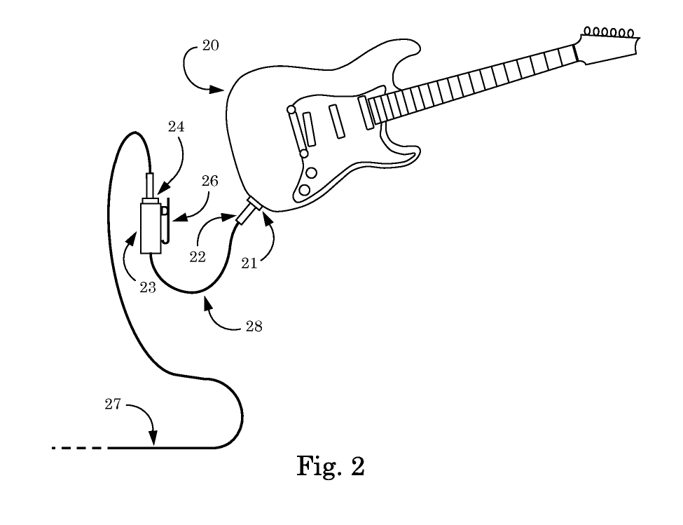

FIG. 2 is a schematic drawing of a portable preamplifier system according to the present invention incorporating a short, shielded input audio cable permanently attached to the preamplifier body. The short, shielded input audio cable 28 is attached to the preamplifier 23 and terminates in an input phone plug 22 which is plugged into the output jack 21 of the guitar 20. The instrument cable 27 is plugged into the output phone jack 24 of the preamplifier 23. The instrument cable 27 delivers amplified and spectrally shaped signals from the guitar 20 to a guitar amplifier/loudspeaker, mixing board, or other audio signal device (not shown). The clip 26 is used to attach the preamplifier 23 to a guitar strap or to the musician's clothing.

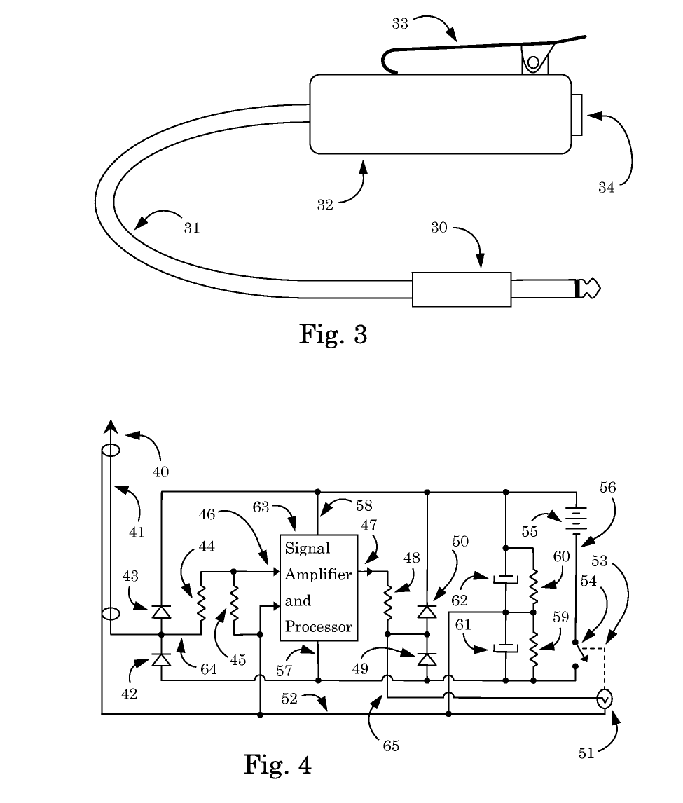

FIG. 3 is an outside view of a portable preamplifier according to the present invention incorporating a short, shielded input audio cable permanently attached to the preamplifier body. The short, shielded input audio cable 31 is permanently attached to the preamplifier body 32 and terminates in a ¼ inch input phone plug 30. The clip 33 is used to attach the preamplifier body 32 to a guitar strap or to the musician's clothing.

FIG. 4 is an electrical circuit block diagram of an electronic signal processing system according to the present invention. The short, shielded input audio cable 41 terminates in a ¼ inch input phone plug 40. The signal at 64 from the musical instrument couples through resistor 44 (typically 10,000 ohms) to the input 46 of the Signal Amplifier and Processor block 63. A large resistor 45 (typically 10 megohms) dissipates any static charge on the input 64 when the input phone plug 40 is not inserted into the musical instrument. This reduces sudden transients (clicks) when the input phone plug 40 is inserted into the musical instrument. The Signal Amplifier and Processor block 63 typically has a FET input stage with input resistance over 1,000,000 megohms and input capacitance less than 10 Pico farads, so that for audio signals there is negligible signal voltage loss across the resistor 44. The amplified signal from the Signal Amplifier and Processor block output at 47 couples through resistor 48 (typically 100 to 1000 ohms) to the output phone jack 51. Resistor 48 improves the stability of the system if the output load is capacitive, such as when a long instrument cable is plugged into the output phone jack 51.

When an instrument cable is inserted into the output phone jack 51, there is a mechanism 53 to close the power switch 54. The switch 54 can be a mechanical switch integrated with phone jack 51 that closes when a phone plug is inserted. Alternatively, phone jack 51 can be a stereo phone jack and the ring contact can be used generate an electrical signal that closes an electronic switch, such as a MOSFET, that acts as the power switch 54.

When the power switch 54 closes, the negative terminal 56 of battery 55 is connected to the Signal Amplifier and Processor block negative power supply input 57. The positive terminal of battery 55 is permanently connected to the Signal Amplifier and Processor block positive power supply input 58. When the power switch 54 closes, the battery voltage is also applied to the voltage divider formed by resistor 59 and resistor 60. These two resistors have equal values (each is typically 20,000 ohms). The common mode voltage at 52 is therefore about halfway between the battery terminal voltages. Common mode voltage is supplied to the input phone plug 40 common terminal, to the output phone jack common terminal, and to the Signal Amplifier and Processor block common mode input. Capacitors 61 and 62 (each is typically 10 microfarads) reduce the voltage fluctuations between the supply lines 57, 52, and 58. Such variations result from time-varying currents into the Signal Amplifier and Processor block supply inputs 57 and 58.

Diodes 42 and 43 provide protection against ESD current into the input phone plug 40. Diode 42 clamps the voltage at 64 to a minimum of a few volts below the negative supply voltage at 57. Diode 43 clamps the voltage at 64 to a maximum of a few volts above the positive supply voltage at 58. Current into the Signal Amplifier and Processor block input 46 resulting from ESD is further limited by resistor 44.

Diodes 49 and 50 provide protection against ESD current into the output phone jack 51. Such ESD current can enter the output phone jack through an instrument cable plugged into the output phone jack 51. Diode 49 clamps the voltage at 65 to a minimum of a few volts below the negative supply voltage at 57. Diode 50 clamps the voltage at 65 to a maximum of a few volts above the positive supply voltage at 58. Current into the Signal Amplifier and Processor block output at 47 resulting from ESD is further limited by resistor 48.

Although the invention has been described in detail for the purpose of illustration, it is understood that such detail is solely for that purpose, and variations can be made therein by those skilled in the art without departing from the spirit and scope of the invention which is defined by the following claims.

I claim:

1. A portable musical instrument preamplifier comprising:
an electronic signal processing system that provides impedance matching, gain, and audio frequency spectrum shaping;
a body containing said electronic signal processing system;
a shielded input audio cable projecting from and permanently attached to said body, terminating in an input phone plug, and electrically coupled to said electronic signal processing system;
a battery as power source for said electronic signal processing system, positioned within said body and accessed through a door or cover plate on said body; and
an output phone jack in said body adapted to electrically connect said electronic signal processing system to an instrument cable, whereby, when said input phone plug is inserted into a musical instrument output jack, said electronic signal processing system produces an amplified and spectrally shaped signal from the instrument capable of being delivered via said instrument cable to a guitar amplifier/loudspeaker, mixing board, or other audio signal device.

2. A portable musical instrument preamplifier according to claim 1 further comprising:
an instrument cable terminated in a phone plug which, when inserted into said preamplifier output phone jack, is electrically coupled to said electronic signal processing system to receive said amplified and spectrally shaped signal.

3. A portable musical instrument preamplifier according to claim 1 further comprising:
a second electronic system that provides non-linear audio signal processing;

4. A portable musical instrument preamplifier according to claim 1 further comprising:
an electrical contact integrated with said preamplifier output phone jack that detects insertion of said instrument cable and upon said insertion causes said battery to be connected to said electronic signal processing system.

5. A portable musical instrument preamplifier according to claim 1 further comprising:
input electronic circuitry to protect said electronic signal processing system from damage that might otherwise result from electrostatic discharge to said input phone plug, wherein said input electronic circuitry is positioned within said body.

6. A portable musical instrument preamplifier according to claim 1, further comprising:
output electronic circuitry to protect said electronic signal processing system from damage that might otherwise result from electrostatic discharge to said preamplifier output phone jack via said instrument cable, wherein said output electronic circuitry is positioned within said body.

7. A portable musical instrument preamplifier according to claim 1, wherein said portable musical instrument is a guitar.

8. A portable musical instrument preamplifier according to claim 1, further comprising:
control means for said electronic signal processing system exteriorly mounted on said body.

9. A portable musical instrument preamplifier according to claim 3, further comprising:
control means for said second electronic system exteriorly mounted on said body.

10. A portable musical instrument preamplifier according to claim 1, further comprising:
a clip or other attachment means exteriorly mounted on said body and adapted to physically connect said body to a guitar strap or to a musician's clothing.
